(19) United States
(12) Patent Application Publication
(10) Pub. No.: US 2026/0277064 A1
(43) Pub. Date: Sep. 17, 2026

(54) PIXEL ARRAY, DRIVING METHOD THEREFOR, AND DISPLAY APPARATUS

(71) Applicant: BOE Technology Group Co., Ltd., Beijing (CN)

(72) Inventors: Zhen ZHANG, Beijing (CN); Minghua XUAN, Beijing (CN); Zhenyu ZHANG, Beijing (CN); Dongni LIU, Beijing (CN); Shunhang ZHANG, Beijing (CN); Lianfu YU, Beijing (CN); Peirou LI, Beijing (CN); Yunsik IM, Beijing (CN)

(21) Appl. No.: 19/168,242

(22) PCT Filed: Sep. 14, 2023
(86) PCT No.: PCT/CN2023/118893

§ 371 Date: Sep. 23, 2025

(51) Int. Cl. G02F 1/1362; G02F 1/1368; G09G 3/36

(52) U.S. Cl. CPC G02F 1/136286; G02F 1/13624; G02F 1/1368; G09G 3/3648; G09G 2300/0426; G09G 2300/0465

(57) ABSTRACT

The pixel array includes: gate lines, data lines, and pixel units P, each pixel unit P including a first sub-pixel, a second sub-pixel and a third sub-pixel arranged in the row direction, where each column of pixel units P is correspondingly provided with one data line, the first sub-pixel and the second sub-pixel are directly electrically connected to the data line of the corresponding column, and the third sub-pixel is electrically connected to the data line of the corresponding column after being connected in series to the second sub-pixel; and each row of pixel units is correspondingly provided with two gate lines, the two gate lines including a first gate line and a second gate line, the first sub-pixel and the third sub-pixel being both connected to the first gate line of the corresponding row, and the second sub-pixel being connected to the second gate line of the corresponding row.

### CROSS-REFERENCE OF RELATED APPLICATIONS

The present application is a national phase entry under 35 U.S.C. § 371 of International Application No. PCT/CN2023/118893, filed on Sep. 14, 2023, and entitled “Pixel Array, Driving Method therefor, and Display Device”, which is hereby incorporated by reference in its entirety.

### TECHNICAL FIELD

The present disclosure relates to the technical field of display, and in particular to a pixel array, a driving method therefor, and a display device.

### BACKGROUND

Thin Film Transistor Liquid Crystal Display (TFT-LCD) has the advantages of small size, low power consumption, high image quality, no radiation and easy portability. It has developed rapidly in recent years and has gradually replaced traditional cathode ray tube display (CRT) and occupied a dominant position in the current flat panel display market.

### SUMMARY

Embodiments of the present disclosure provide a pixel array, a driving method therefor, and a display device, the specific solutions are as follows.

Embodiments of the present disclosure provide a pixel array, including:
a plurality of gate lines extending in a row direction and arranged in a column direction;
a plurality of data lines extending in the column direction and arranged in the row direction;
a plurality of pixel units arranged in an array in the row direction and the column direction; where:
each of the plurality of pixel units includes: a first sub-pixel, a second sub-pixel and a third sub-pixel arranged in the row direction;
each column of the plurality of pixel units corresponds to a data line, the first sub-pixel and the second sub-pixel are directly electrically connected to the data line of a corresponding column, and the third sub-pixel is electrically connected to the data line of the corresponding column by being connected in series with the second sub-pixel;
each row of the plurality of pixel units corresponds to two gate lines, the two gate lines include a first gate line and a second gate line, the first sub-pixel and the third sub-pixel are both connected to the first gate line of a corresponding row, and the second sub-pixel is connected to the second gate line of the corresponding row.

In some embodiments, the first sub-pixel includes: a first thin film transistor and a first pixel electrode; the second sub-pixel includes: a second thin film transistor and a second pixel electrode; and the third sub-pixel includes: a third thin film transistor and a third pixel electrode;
a gate electrode of the first thin film transistor and a gate electrode of the third thin film transistor are both connected to the first gate line, and a gate electrode of the second thin film transistor is connected to the second gate line;
a first electrode of the first thin film transistor and a first electrode of the second thin film transistor are directly electrically connected to the data line of the corresponding column;
a second electrode of the first thin film transistor is electrically connected to the first pixel electrode, a second electrode of the second thin film transistor is electrically connected to the second pixel electrode;
a first electrode of the third thin film transistor is electrically connected to the second electrode of the second thin film transistor, and the second electrode of the third thin film transistor is electrically connected to the third pixel electrode.

In some embodiments, the first sub-pixel, the second sub-pixel, and the third sub-pixel are arranged in sequence in the row direction; and the data line is arranged between the first sub-pixel and the second sub-pixel.

In some embodiments, the first sub-pixel emits red light, the second sub-pixel emits green light, and the third sub-pixel emits blue light; or
the first sub-pixel emits blue light, the second sub-pixel emits green light, and the third sub-pixel emits red light.

In some embodiments, the second sub-pixel, the first sub-pixel and the third sub-pixel are arranged in sequence in the row direction, and the data line is arranged on a side of the second sub-pixel facing away from the first sub-pixel.

In some embodiments, the second sub-pixel emits red light, the first sub-pixel emits green light, and the third sub-pixel emits blue light; or
the second sub-pixel emits blue light, the first sub-pixel emits green light, and the third sub-pixel emits red light.

In some embodiments, the two gate lines corresponding to each row of the plurality of pixel units are arranged on a same side of the plurality of pixel units in the corresponding row.

In some embodiments, a plurality of thin film transistors corresponding to each row of the plurality of pixel units are arranged between the two gate lines of the corresponding row of the plurality of pixel units.

Embodiments of the present disclosure further provide a display device, including a display panel, where the display panel includes the pixel array in any one the above embodiments of the present disclosure.

Embodiments of the present disclosure further provide a method for driving a pixel array, for driving the pixel array in any one the above embodiments of the present disclosure, when displaying a frame of pixel images, the driving method includes:
controlling the first gate line and the second gate line to be turned on at the same time, inputting a date voltage corresponding to the third sub-pixel to the first sub-pixel, the second sub-pixel and the third sub-pixel through the data line;
controlling the first gate line to be turned on, controlling the second gate line to be turned off, and inputting a data voltage corresponding to the first sub-pixel to the first sub-pixel through the data line;
controlling the first gate line to be turned off, controlling the second gate line to be turned on, and inputting a data voltage corresponding to the second sub-pixel to the second sub-pixel through the data line.

Embodiments of the present disclosure further provide a method for driving a pixel array, for driving the pixel array in any one the above embodiments of the present disclosure, when displaying a frame of pixel images, the driving method includes:
controlling the first gate line and the second gate line to be turned on at the same time, inputting a date voltage corresponding to the third sub-pixel to the first sub-pixel, the second sub-pixel and the third sub-pixel through the data line;
controlling the first gate line to be turned off, controlling the second gate line to be turned on, and inputting a data voltage corresponding to the second sub-pixel to the second sub-pixel through the data line;
controlling the first gate line to be turned on, controlling the second gate line to be turned off, and inputting a data voltage corresponding to the first sub-pixel to the first sub-pixel through the data line.

### BRIEF DESCRIPTION OF FIGURES

FIG. 1 is a schematic structural diagram of a pixel array provided by the related art.

FIG. 2 is another schematic structural diagram of a pixel array provided by the related art.

FIG. 3 is another schematic structural diagram of a pixel array provided by the related art.

FIG. 4 is a schematic structural diagram of a pixel array provided by embodiments of the present disclosure.

FIG. 5 is a schematic diagram of a layout corresponding to a pixel unit in FIG. 4.

FIG. 6 is another schematic structural diagram of a pixel array provided by embodiments of the present disclosure.

FIG. 7 is a schematic diagram of a layout corresponding to a pixel unit in FIG. 6.

FIG. 8 is another schematic structural diagram of a pixel array provided by embodiments of the present disclosure.

FIG. 9 is a schematic diagram of a layout corresponding to a pixel unit in FIG. 8.

FIG. 10 is another schematic structural diagram of a pixel array provided by embodiments of the present disclosure.

FIG. 11 is a schematic diagram of a layout corresponding to a pixel unit in FIG. 10.

FIG. 12 is another schematic structural diagram of a pixel array provided by embodiments of the present disclosure.

FIG. 13 is another schematic structural diagram of a pixel array provided by embodiments of the present disclosure.

FIG. 14 is another schematic structural diagram of a pixel array provided by embodiments of the present disclosure.

FIG. 15 is another schematic structural diagram of a pixel array provided by embodiments of the present disclosure.

FIG. 16 is a flow chart of a driving method for a pixel array provided by embodiments of the present disclosure.

FIG. 17 is a flow chart of a method for driving a pixel array provided by embodiments of the present disclosure.

FIG. 18 is a schematic structural diagram of a display device provided by embodiments of the present disclosure.

### DETAILED DESCRIPTION

In order to make the purpose, technical solutions and advantages of embodiments of the present disclosure more clear, the technical solutions of the embodiments of the present disclosure will be clearly and completely described below in conjunction with the drawings of embodiments of the present disclosure. Obviously, the described embodiments are some, but not all, of the embodiments of the present disclosure. And the embodiments and features in the embodiments of the present disclosure may be combined with each other without conflict. Based on the described embodiments of the present disclosure, all other embodiments obtained by those of ordinary skill in the art without creative efforts fall within the scope of the present disclosure

Unless otherwise defined, technical terms or scientific terms used in this disclosure shall have the usual meaning understood by a person with ordinary skill in the art to which this disclosure belongs. Words such as “including” or “comprising” refer to the components or objects that appear before the word, including those listed after the word and their equivalents, without excluding other components or objects. Words such as “connected” or “connecting” are not limited to physical or mechanical connections, but may include electrical connections, whether direct or indirect. Words such as “inside”, “outside”, “up”, “down” are only used to express relative positional relationships. When the absolute position of the described object is changed, the relative positional relationship may also be changed accordingly.

It should be noted that the sizes and shapes of the figures in the drawings do not reflect true proportions and are only intended to illustrate the present disclosure. And, the same or similar reference numbers throughout represent the same or similar components or elements having the same or similar functions.

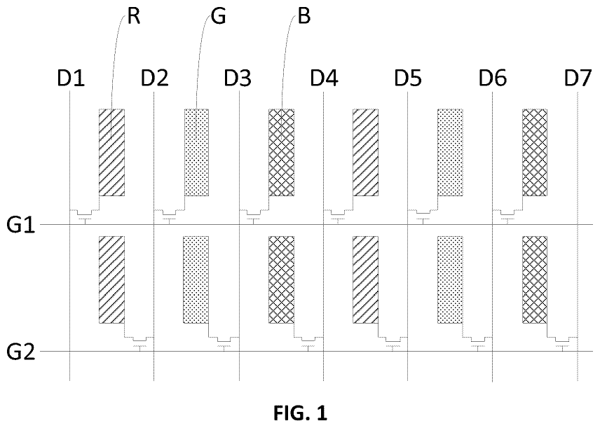

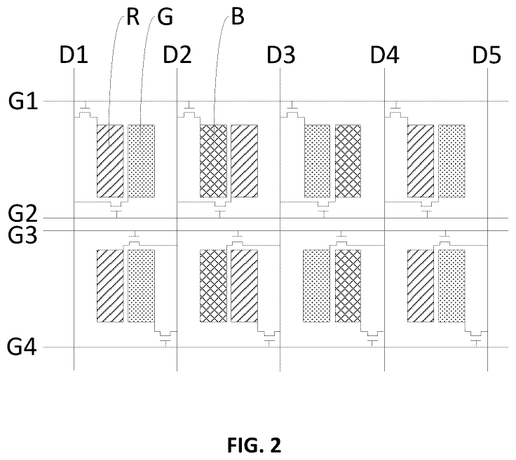

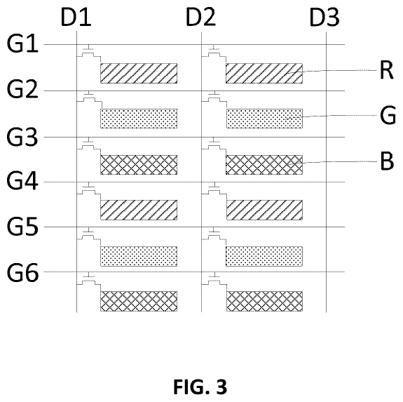

Currently commonly used pixel structures include Single Gate (single gate, each row of pixel units is driven by one scanning line), Dual gate (dual gate, each row of pixel units is driven by two scanning lines) and Triple Gate (triple gate, each row of pixel units is driven by three scanning lines), as shown in FIGS. 1 to 3, FIG. 1 is a single-gate pixel structure provided by the related art, FIG. 2 is a dual-gate pixel structure provided by the related art, and FIG. 3 is a triple-gate pixel structure provided by the related art, where G1, G2 . . . are scanning lines, D1, D2 . . . are data lines, and each pixel unit includes multiple sub-pixels of different luminous colors (for example, R, G, B). Under the same display panel resolution, different pixel structures require different numbers of source driver ICs (integrated circuits), which in turn affects the production cost of the display panel. Compared with the single-gate pixel structure shown in FIG. 1, the dual-gate pixel structure shown in FIG. 2 can reduce the number of source driver ICs to ⅔ of that in FIG. 1, and the triple-gate pixel structure shown in FIG. 3 can reduce the number of source driver ICs to ⅓ of that in FIG. 1. Thus, the triple-gate pixel structure shown in FIG. 3 can greatly reduce the production cost of the source driver ICs. However, since the three-gate pixel structure requires a large number of gate lines, the gate lines occupy a large area of the display region, thereby reducing the aperture ratio of the display panel. Therefore, how to provide a device that can reduce the number of source driver ICs to ⅓ of that in FIG. 1 while increasing the aperture ratio of the display region is a technical problem that those skilled in the art urgently need to solve.

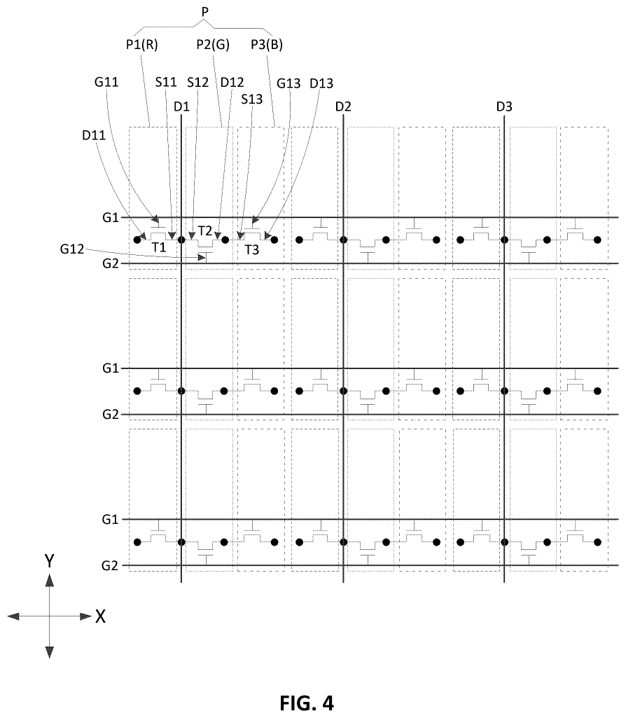

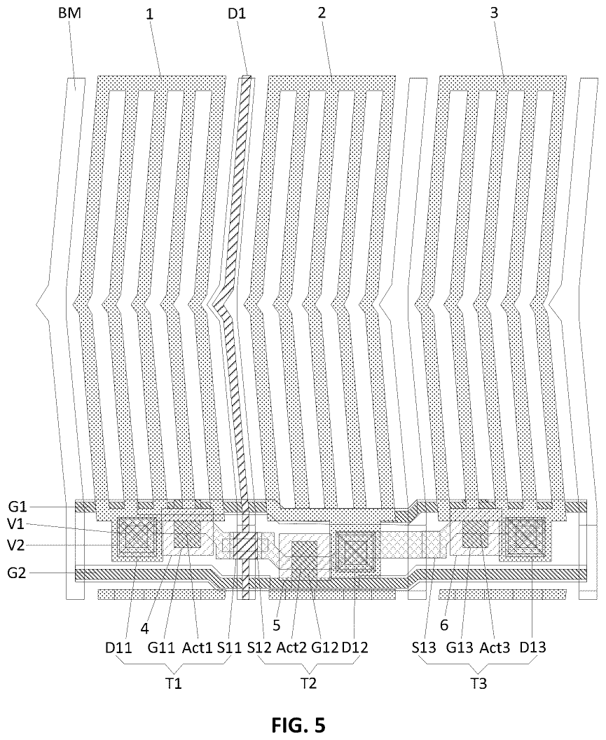

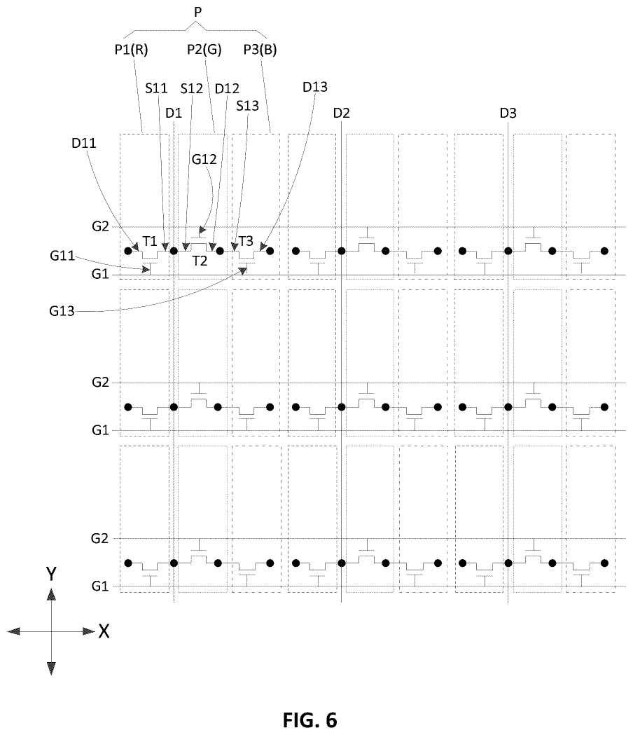

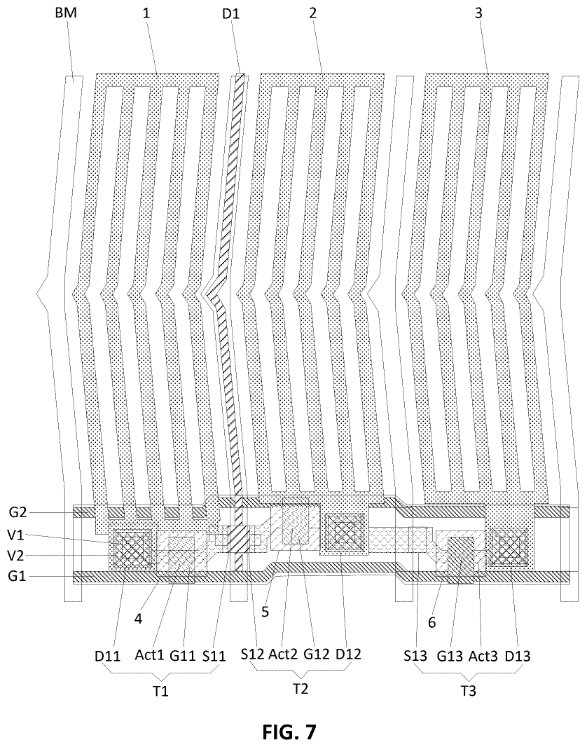

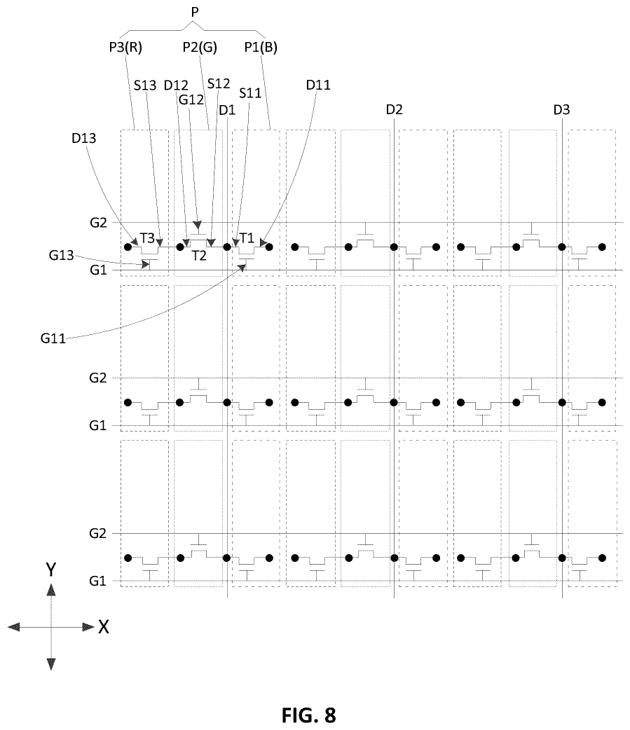

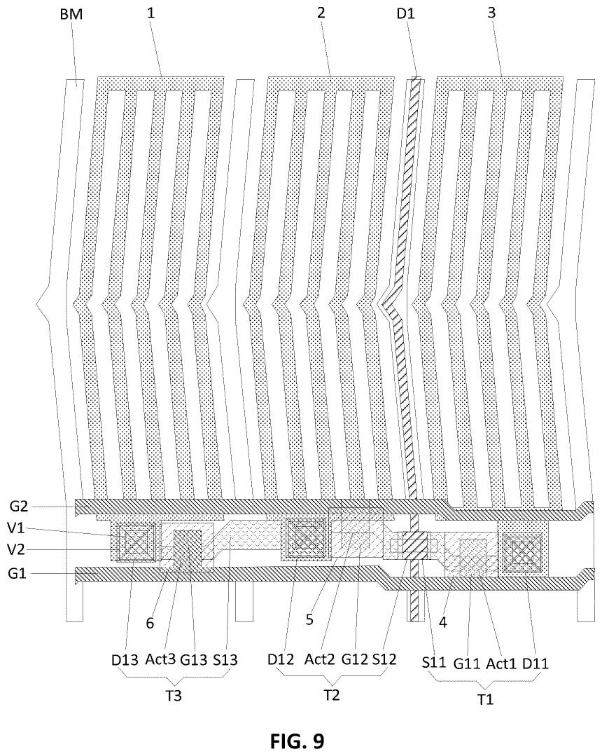

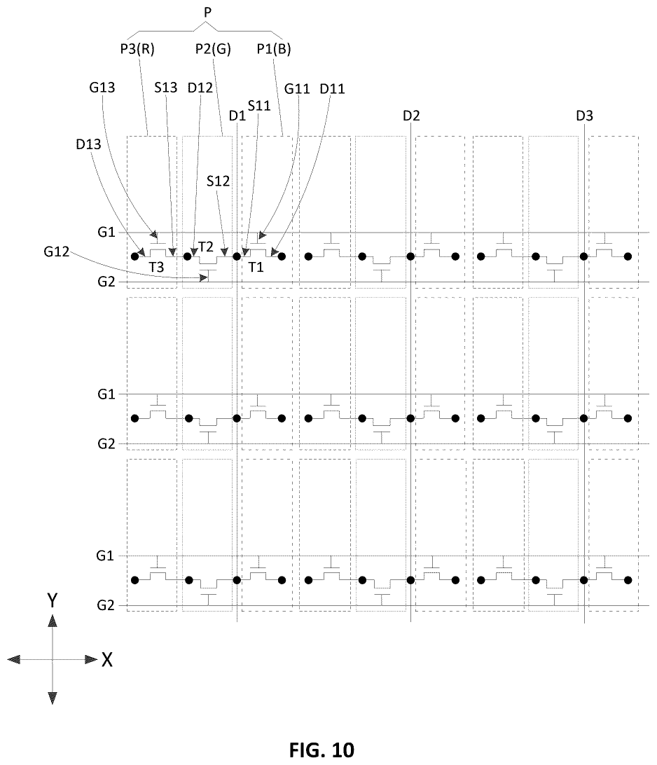

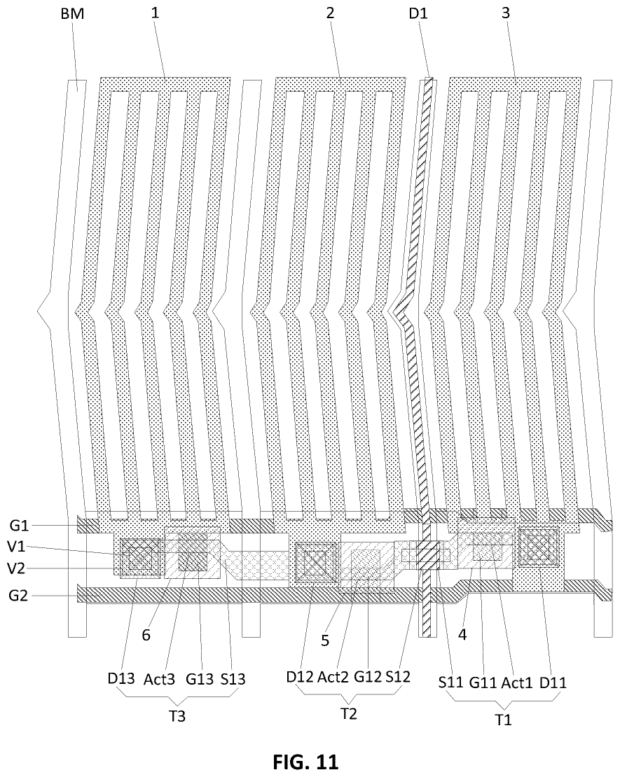

In view of this, embodiments of the present disclosure provide a pixel array, as shown in FIGS. 4 to 15. FIGS. 4, 6, 8, 10, and 12 to 15 are respectively schematic structural diagrams of the pixel array provided by embodiments of the present disclosure. FIG. 5 is a schematic diagram of a layout corresponding to a pixel unit in FIG. 4, FIG. 7 is a schematic diagram of a layout corresponding to a pixel unit in FIG. 6, FIG. 9 is a schematic diagram of a layout corresponding to a pixel unit in FIG. 8, and FIG. 11 is a schematic diagram of a layout corresponding to a pixel unit in FIG. 10. The pixel array includes:
a plurality of gate lines (G1, G2, G1, G2, . . . ) extending in a row direction X and arranged in a column direction Y;
a plurality of data lines (D1, D2, D3, . . . ) extending in the column direction Y and arranged in the row direction X;
a plurality of pixel units P arranged in an array in the row direction X and the column direction Y; where: each of the plurality of pixel units P includes: a first sub-pixel P1, a second sub-pixel P2 and a third sub-pixel P3 arranged in the row direction X.

Each column of the plurality of pixel units P corresponds to a data line (for example, the first column of pixel units P from the left corresponds to the data line D1, the second column of pixel units P from the left corresponds to the data line D2, the third column of pixel units P from the left corresponds to the data line D3 . . . ), the first sub-pixel P1 and the second sub-pixel P2 are directly electrically connected to the data line of a corresponding column(for example, each first sub-pixel P1 and each second sub-pixel P2 in the first column of pixel units P is directly electrically connected to the data line D1 corresponding to the first column of pixel units P, each first sub-pixel P1 and each second sub-pixel P2 in the second column of pixel units P is directly electrically connected to the data line D2 corresponding to the second column of pixel units P, and each first sub-pixel P1 and each second pixel P2 in the third column of pixel units P is directly electrically connected to the data line D1 corresponding to the third column of pixel units P . . . ), and the third sub-pixel P3 is electrically connected to the data line of the corresponding column by being connected in series with the second sub-pixel (for example, each third sub-pixel P3 in the first column of pixel units P is electrically connected to the data line D1 corresponding to the first column of pixel units P by being connected in series with the corresponding second sub-pixel P2, each third sub-pixel P3 in the second column of pixel units P is electrically connected to the data line D2 corresponding to the second column of pixel units P by being connected in series with the corresponding second sub-pixel P2, and each third sub-pixel P3 in the third column of pixel units P is electrically connected to the data line D3 corresponding to the third column of pixel units P by being connected in series with the corresponding second sub-pixel P2 . . . ). Each row of the plurality of pixel units P corresponds to two gate lines, the two gate lines include a first gate line G1 and a second gate line G2, the first sub-pixel P1 and the third sub-pixel P3 are both connected to the first gate line G1 of a corresponding row, and the second sub-pixel P2 is connected to the second gate line G2 of the corresponding row.

The above-mentioned pixel array provided by embodiments of the present disclosure can realize display driving of different sub-pixels by using one data line and two gate lines for each pixel unit. Compared with the three-gate pixel structure in the related art, the present disclosure can reduce the number of data lines to ⅓ of the single-gate pixel structure while also reducing the number of gate lines for each row of pixel units. This can increase the display area and improve the aperture ratio on the one hand; on the other hand, the reduction in the number of gate lines can also reduce the parasitic capacitance between the gate lines and other signal lines (such as data lines, power lines, etc.), thereby increasing the charging time of each row of pixel units, ensuring the charging rate, and improving the display effect.

In some embodiments, in the above pixel array provided by embodiments of the present disclosure, as shown in FIG. 4 to FIG. 15, the first sub-pixel P1 includes a first thin film transistor T1 and a first pixel electrode 1, the second sub-pixel P2 includes a second thin film transistor T2 and a second pixel electrode 2, and the third sub-pixel P3 includes a third thin film transistor T3 and a third pixel electrode 3.

The gate electrode G11 of the first thin film transistor T1 and the gate electrode G13 of the third thin film transistor T3 are both connected to the first gate line G1, and the gate electrode G12 of the second thin film transistor T2 is connected to the second gate line G2.

The first electrode S11 of the first thin-film transistor T1 and the first electrode S12 of the second thin-film transistor T2 are directly electrically connected to the data line of the corresponding column (for example, the first electrode S11 of each first thin-film transistor T1 and the first electrode S12 of each second thin-film transistor T2 in the first column of pixel units P are directly electrically connected to the data line D1 corresponding to the first column of pixel units P, the first electrode S11 of each first thin-film transistor T1 and the first electrode S12 of each second thin-film transistor T2 in the second column of pixel units P are directly electrically connected to the data line D2 corresponding to the second column of pixel units P, the first electrode S11 of each first thin-film transistor T1 and the first electrode S12 of each second thin-film transistor T2 in the third column of pixel units P are directly electrically connected to the data line D3 corresponding to the third column of pixel units P, etc.), the second electrode D11 of the first thin-film transistor T1 is electrically connected to the first pixel electrode 1, the second electrode D12 of the second thin-film transistor T2 is electrically connected to the second pixel electrode 2, the first electrode S13 of the third thin-film transistor T3 is electrically connected to the second electrode D12 of the second thin-film transistor T2, and the second electrode D13 of the third thin-film transistor T3 is electrically connected to the third pixel electrode 3.

In some embodiments, in the pixel array provided by embodiments of the present disclosure, as shown in FIGS. 5, 7, 9, and 11, the first thin-film transistor T1 further includes a first active layer Act1, the second thin-film transistor T2 further includes a second active layer Act2, and the third thin-film transistor T3 further includes a third active layer Act3. The first active layer Act1, the second active layer Act2, and the third active layer Act3 can be an integral structure. Except for the semiconductor region overlapping with each gate electrode, the remaining portions of the integral structure can be semiconductor-doped conductors. Thus, the first electrode S11 (e.g., source electrode) of the first thin-film transistor T1 is fabricated using a source-drain metal layer, and the second electrode D11 (e.g., drain electrode) of the first thin-film transistor T1 can be directly a conductor on one side of the first active layer Act1. Thus, the first pixel electrode 1 can be electrically connected to the conductor on one side of the first active layer Act1 through a first via hole V1 penetrating through the passivation layer and a second via hole V2 penetrating through the planarization layer. The first via hole V1 and the second via hole V2 are sleeve holes. In some embodiments, the manufacturing process of the first electrode and the second electrode of the second thin film transistor T2 and the first electrode and the second electrode of the third thin film transistor T3 is similar to that of the first thin film transistor T1, and will not be described in detail here.

In some embodiments, in the above-mentioned pixel array provided by embodiments of the present disclosure, as shown in FIGS. 5, 7, 9 and 11, when manufacturing a thin film transistor, a source-drain metal layer can be first manufactured on the base substrate, and then an active layer can be manufactured, and then a gate electrode layer can be manufactured. In this way, the source-drain metal layer can also be used to shield the active layer of the thin film transistor to prevent light from damaging the performance of the thin film transistor. For example, a first blocking portion 4 which is arranged on the same layer as the source-drain metal layer is provided under the first active layer Act1 of the first thin film transistor T1, a second blocking portion 5 which is arranged on the same layer as the source-drain metal layer is provided under the second active layer Act2 of the second thin film transistor T2, and a third blocking portion 6 which is arranged on the same layer as the source-drain metal layer is provided under the third active layer Act3 of the third thin film transistor T3.

In some embodiments, as shown in FIG. 4 to FIG. 15, the sub-pixels in the same column emit the same color, and the sub-pixels in the same row are arranged in red, green, and blue order. Each pixel unit realizes display driving by adopting one data line and two gate lines to drive three thin film transistors, where the second thin film transistor T2 and the third thin film transistor T3 are designed to be connected in series. The first gate line G1 drives the first thin film transistor T1 and the third thin film transistor T3, and the second gate line G2 drives the second thin film transistor T2. The first sub-pixel P1 realizes the writing of charging data of the first sub-pixel P1 through the switching of the first thin-film transistor T1, the second sub-pixel P2 realizes the writing of charging data of the second sub-pixel P2 through the switching of the second thin-film transistor T2, and the third sub-pixel P3 realizes the writing of charging data of the third sub-pixel P3 through the switching of the second thin-film transistor T2 and the third thin-film transistor T3. The writing of charging data of the third sub-pixel P3 is realized only when the second thin-film transistor T2 and the third thin-film transistor T3 are turned on at the same time. When only one of the second thin-film transistor T2 and the third thin-film transistor T3 is turned on, the third sub-pixel P3 cannot be charged. Therefore, by adopting the pixel array arrangement shown in FIGS. 4 to 15 provided by embodiments of the present disclosure, and coordinating the switching of the first thin film transistor T1, the second thin film transistor T2 and the third thin film transistor T3 with corresponding timing control, the display driving of the first sub-pixel P1, the second sub-pixel P2 and the third sub-pixel P3 can be realized.

In some embodiments, in the above-mentioned pixel array provided by embodiments of the present disclosure, as shown in FIGS. 4 to 11, the first sub-pixel P1, the second sub-pixel P2 and the third sub-pixel P3 are arranged in sequence along the row direction X, and the data line (D1, D2, D3 . . . ) is arranged between the first sub-pixel P1 and the second sub-pixel P2. In some embodiments, since the third sub-pixel P3 is connected in series with the second sub-pixel P2, that is, the third thin-film transistor T3 and the second thin-film transistor T2 are connected in series, by setting the data line (D1, D2, D3, . . . ) between the first sub-pixel P1 and the second sub-pixel P2, the first electrode S11 of the first thin-film transistor T1 and the first electrode S12 of the second thin-film transistor T2 can be electrically connected to the data line arranged between the first thin-film transistor T1 and the second thin-film transistor T2, thereby simplifying the layout difficulty of the pixel array. Of course, the data lines (D1, D2, D3 . . . ) are not limited to being arranged between the first sub-pixel P1 and the second sub-pixel P2, but can also be set at other positions, as long as the connection relationship between the thin film transistors and the connection relationship between the thin film transistors and the data lines in FIGS. 4 to 11 can be achieved.

In some embodiments, in the above-mentioned pixel array provided by embodiments of the present disclosure, as shown in FIGS. 4 to 7, the first sub-pixel P1, the second sub-pixel P2 and the third sub-pixel P3 are arranged in sequence from left to right along the row direction X, the luminous color of the first sub-pixel P1 is red (R), the luminous color of the second sub-pixel P2 is green (G), and the luminous color of the third sub-pixel P3 is blue (B). In this way, the leftmost sub-pixel in each pixel unit P is the first sub-pixel P1, and the luminous color is red (R); the middle position in each pixel unit P is the second sub-pixel P2, and the luminous color is green (G); and the rightmost sub-pixel in each pixel unit P is the third sub-pixel P3, and the luminous color is blue (B).

In some embodiments, in the above-mentioned pixel array provided by embodiments of the present disclosure, as shown in FIGS. 4 and 5, each row of pixel units P corresponds to a first gate line G1 and a second gate line G2, where the first gate line G1 is farther away from the next row of pixel units P, and the second gate line G2 is closer to the next row of pixel units P.

In some embodiments, in the above-mentioned pixel array provided by embodiments of the present disclosure, as shown in FIGS. 6 and 7, each row of pixel units P corresponds to a first gate line G1 and a second gate line G2, where the second gate line G2 is farther away from the next row of pixel units P, and the first gate line G1 is closer to the next row of pixel units P.

In some embodiments, when the pixel array shown in FIG. 4 to FIG. 7 displays a frame of pixel images, the specific driving method includes the following steps (taking the display of the first row of pixel units P as an example).
(1) The first gate line G1 and the second gate line G2 corresponding to the first row of pixel units P are controlled to be turned on at the same time, and the first thin film transistor T1, the second thin film transistor T2 and the third thin film transistor T3 are turned on at the same time. The data voltage b corresponding to the third sub-pixel P3 is input to the first sub-pixel P1, the second sub-pixel P2 and the third sub-pixel P3 through the data lines (D1, D2, D3 . . . ). The pixel voltages of the first sub-pixel P1, the second sub-pixel P2 and the third sub-pixel P3 are all charged to the data voltage b. At this time, the data voltages of the first sub-pixel P1, the second sub-pixel P2 and the third sub-pixel P3 from left to right along the row direction X are all b.
(2) The first gate line G1 is controlled to be turned on, and the second gate line G2 is controlled to be turned off. At this time, the first thin film transistor T1 and the third thin film transistor T3 are turned on at the same time, and the second thin film transistor T2 is turned off. The data voltage r corresponding to the first sub-pixel P1 is input to the first sub-pixel P1 through the data line (D1, D2, D3 . . . ) . At this time, the pixel voltage of the first sub-pixel P1 is charged to r because the first thin film transistor T1 is turned on, and the pixel voltage of the second sub-pixel P2 continues to be the data voltage b because the second thin film transistor T2 is turned off. The pixel voltage of the third sub-pixel P3 continues to be the data voltage b because the third thin film transistor T3 is turned on and the second thin film transistor T2 is turned off. At this time, the data voltages of the first sub-pixel P1, the second sub-pixel P2 and the third sub-pixel P3 from left to right along the row direction X are r, b, and b respectively.
(3) The first gate line G1 is controlled to be turned off, and the second gate line G2 is controlled to be turned on. At this time, the first thin film transistor T1 and the third thin film transistor T3 are both turned off, and the second thin film transistor T2 is turned on. The data voltage g corresponding to the second sub-pixel P2 is input to the second sub-pixel P2 through the data line (D1, D2, D3 . . . ) . At this time, the pixel voltage of the first sub-pixel P1 continues to be the data voltage r because the first thin film transistor T1 is turned off. The pixel voltage of the second sub-pixel P2 is charged to the data voltage g because the second thin film transistor T2 is turned on. The pixel voltage of the third sub-pixel P3 continues to be the data voltage b because the second thin film transistor T2 is turned on and the third thin film transistor T3 is turned off. At this time, the data voltages of the first sub-pixel P1, the second sub-pixel P2 and the third sub-pixel P3 from left to right along the row direction X are r, g, and b respectively.
(4) The first gate line G1 and the second gate line G2 are both turned off, and the first thin film transistor T1, the second thin film transistor T2 and the third thin film transistor T3 are all turned off. From left to right along the row direction X, the first sub-pixel P1 maintains the data voltage r, the second sub-pixel P2 maintains the data voltage g, and the third sub-pixel P3 maintains the data voltage b. The first row of pixel unit arrays realizes normal light-emitting display.

Afterwards, the second row of pixel units P, the third row of pixel units P, etc. in sequence implement the light-emitting display of each row according to the above steps (1) to (4).

In some embodiments, the pixel array shown in FIG. 4 to FIG. 7 can also adopt the following driving method when displaying a frame of pixel images (taking the display of the first row of pixel units P as an example).
(1) The first gate line G1 and the second gate line G2 corresponding to the first row of pixel units P are controlled to be turned on at the same time, and the first thin film transistor T1, the second thin film transistor T2 and the third thin film transistor T3 are turned on at the same time. The data voltage b corresponding to the third sub-pixel P3 is input to the first sub-pixel P1, the second sub-pixel P2 and the third sub-pixel P3 through the data lines (D1, D2, D3 . . . ). The pixel voltages of the first sub-pixel P1, the second sub-pixel P2 and the third sub-pixel P3 are all charged to the data voltage b. At this time, the data voltages of the first sub-pixel P1, the second sub-pixel P2 and the third sub-pixel P3 from left to right along the row direction X are all b.
(2) The first gate line G1 is controlled to be turned off, and the second gate line G2 is controlled to be turned on. At this time, the first thin film transistor T1 and the third thin film transistor T3 are turned off at the same time, and the second thin film transistor T2 is turned on. The data voltage g corresponding to the second sub-pixel P2 is input to the second sub-pixel P2 through the data line (D1, D2, D3 . . . ). At this time, the pixel voltage of the second sub-pixel P2 is charged to g because the second thin film transistor T2 is turned on. The pixel voltage of the first sub-pixel P1 continues to be the data voltage b because the first thin film transistor T1 is turned off. The pixel voltage of the third sub-pixel P3 continues to be the data voltage b because the third thin film transistor T3 is turned off and the second thin film transistor T2 is turned on. At this time, the data voltages of the first sub-pixel P1, the second sub-pixel P2 and the third sub-pixel P3 from left to right along the row direction X are b, g, and b respectively.
(3) The first gate line G1 is controlled to be turned on, and the second gate line G2 is controlled to be turned off. At this time, the first thin film transistor T1 and the third thin film transistor T3 are both turned on, and the second thin film transistor T2 is turned off. The data voltage r corresponding to the first sub-pixel P1 is input to the first sub-pixel P1 through the data line (D1, D2, D3 . . . ). At this time, the pixel voltage of the first sub-pixel P1 is charged to the data voltage r because the first thin film transistor T1 is turned on. The pixel voltage of the second sub-pixel P2 continues to be maintained at the data voltage g because the second thin film transistor T2 is turned off. The pixel voltage of the third sub-pixel P3 continues to be maintained at the data voltage b because the second thin film transistor T2 is turned off and the third thin film transistor T3 is turned on. At this time, the data voltages of the first sub-pixel P1, the second sub-pixel P2 and the third sub-pixel P3 from left to right along the row direction X are r, g and b respectively.
(4) The first gate line G1 and the second gate line G2 are both turned off, and the first thin film transistor T1, the second thin film transistor T2 and the third thin film transistor T3 are all turned off. From left to right along the row direction X, the first sub-pixel P1 maintains the data voltage r, the second sub-pixel P2 maintains the data voltage g, and the third sub-pixel P3 maintains the data voltage b. The first row of pixel unit arrays realizes normal light-emitting display.

Afterwards, the second row of pixel units P, the third row of pixel units P, etc. in sequence implement the light-emitting display of each row according to the above steps (1) to (4).

In some embodiments, in the above-mentioned pixel array provided by embodiments of the present disclosure, as shown in FIGS. 8 to 11, the first sub-pixel P1, the second sub-pixel P2 and the third sub-pixel P3 are arranged in sequence from right to left along the row direction X, the luminous color of the first sub-pixel P1 is blue (B), the luminous color of the second sub-pixel P2 is green (G), and the luminous color of the third sub-pixel P3 is red (R). In this way, the leftmost sub-pixel in each pixel unit P is the third sub-pixel P3, and the luminous color is red (R); the middle position in each pixel unit P is the second sub-pixel P2, and the luminous color is green (G); and the rightmost sub-pixel in each pixel unit P is the first sub-pixel P1, and the luminous color is blue (B).

In some embodiments, in the above-mentioned pixel array provided by embodiments of the present disclosure, as shown in FIGS. 8 and 9, each row of pixel units P corresponds to a first gate line G1 and a second gate line G2, where the second gate line G2 is farther away from the next row of pixel units P, and the first gate line G1 is closer to the next row of pixel units P.

In some embodiments, in the above-mentioned pixel array provided by embodiments of the present disclosure, as shown in FIGS. 10 and 11, each row of pixel units P corresponds to a first gate line G1 and a second gate line G2, where the first gate line G1 is farther away from the next row of pixel units P, and the second gate line G2 is closer to the next row of pixel units P.

In some embodiments, when the pixel array shown in FIG. 8 to FIG. 11 displays a frame of pixel images, the specific driving method includes the following steps (taking the display of the first row of pixel units P as an example).
(1) The first gate line G1 and the second gate line G2 corresponding to the first row of pixel units P are controlled to be turned on at the same time, and the first thin film transistor T1, the second thin film transistor T2 and the third thin film transistor T3 are turned on at the same time. The data voltage r corresponding to the third sub-pixel P3 is input to the first sub-pixel P1, the second sub-pixel P2 and the third sub-pixel P3 through the data lines (D1, D2, D3 . . . ). The pixel voltages of the first sub-pixel P1, the second sub-pixel P2 and the third sub-pixel P3 are all charged to the data voltage r. At this time, the data voltages of the third sub-pixel P3, the second sub-pixel P2 and the first pixel P1 from left to right along the row direction X are all r.
(2) The first gate line G1 is controlled to be turned on, and the second gate line G2 is controlled to be turned off. At this time, the first thin film transistor T1 and the third thin film transistor T3 are turned on at the same time, and the second thin film transistor T2 is turned off. The data voltage b corresponding to the first sub-pixel P1 is input to the first sub-pixel P1 through the data lines (D1, D2, D3 . . . ). At this time, the pixel voltage of the third sub-pixel P3 continues to be the data voltage r because the second thin film transistor T2 is turned off and the third thin film transistor T3 is turned on. The pixel voltage of the second sub-pixel P2 continues to be the data voltage r because the second thin film transistor T2 is turned off. The pixel voltage of the first sub-pixel P1 is charged to b because the first thin film transistor T1 is turned on. At this time, the data voltages of the third sub-pixel P3, the second sub-pixel P2 and the first pixel P1 from left to right along the row direction X are r, r, and b respectively.
(3) The first gate line G1 is controlled to be turned off, and the second gate line G2 is controlled to be turned on. At this time, the second thin film transistor T2 is turned on, and the first thin film transistor T1 and the third thin film transistor T3 are both turned off. The data voltage g corresponding to the second sub-pixel P2 is input to the second sub-pixel P2 through the data line (D1, D2, D3 . . . ). At this time, the pixel voltage of the second sub-pixel P2 is charged to the data voltage g because the second thin film transistor T2 is turned on. The pixel voltage of the first sub-pixel P1 continues to be the data voltage b because the first thin film transistor T1 is turned off. The pixel voltage of the third sub-pixel P3 continues to be the data voltage r because the second thin film transistor T2 is turned on and the third thin film transistor T3 is turned off. At this time, the data voltages of the third sub-pixel P3, the second sub-pixel P2 and the first pixel P1 from left to right along the row direction X are r, g and b respectively.
(4) The first gate line G1 and the second gate line G2 are both turned off, and the first thin film transistor T1, the second thin film transistor T2 and the third thin film transistor T3 are all turned off. From left to right along the row direction X, the third sub-pixel P3 maintains the data voltage r, the second sub-pixel P2 maintains the data voltage g, and the first sub-pixel P1 maintains the data voltage b. The first row of pixel unit arrays realizes normal light-emitting display.

Afterwards, the second row of pixel units P, the third row of pixel units P, etc. in sequence implement the light-emitting display of each row according to the above steps (1) to (4).

In some embodiments, the pixel array shown in FIG. 8 to FIG. 11 can also adopt the following driving method when displaying a frame of pixel images (taking the display of the first row of pixel units P as an example).
(1) The first gate line G1 and the second gate line G2 corresponding to the first row of pixel units P are controlled to be turned on at the same time, and the first thin film transistor T1, the second thin film transistor T2 and the third thin film transistor T3 are turned on at the same time. The data voltage r corresponding to the third sub-pixel P3 is input to the first sub-pixel P1, the second sub-pixel P2 and the third sub-pixel P3 through the data lines (D1, D2, D3 . . . ). The pixel voltages of the first sub-pixel P1, the second sub-pixel P2 and the third sub-pixel P3 are all charged to the data voltage r. At this time, the data voltages of the third sub-pixel P3, the second sub-pixel P2 and the first pixel P1 from left to right along the row direction X are all r.
(2) The first gate line G1 is controlled to be turned off, and the second gate line G2 is controlled to be turned on. At this time, the first thin film transistor T1 and the third thin film transistor T3 are turned off at the same time, and the second thin film transistor T2 is turned on. The data voltage g corresponding to the second sub-pixel P2 is input to the second sub-pixel P2 through the data line (D1, D2, D3 . . . ). At this time, the pixel voltage of the second sub-pixel P2 is charged to g because the second thin film transistor T2 is turned on. The pixel voltage of the first sub-pixel P1 continues to be the data voltage r because the first thin film transistor T1 is turned off. The pixel voltage of the third sub-pixel P3 continues to be the data voltage r because the third thin film transistor T3 is turned off and the second thin film transistor T2 is turned on. At this time, the data voltages of the third sub-pixel P3, the second sub-pixel P2 and the first pixel P1 from left to right along the row direction X are r, g, and r respectively.
(3) The first gate line G1 is controlled to be turned on, and the second gate line G2 is controlled to be turned off. At this time, the first thin film transistor T1 and the third thin film transistor T3 are both turned on, and the second thin film transistor T2 is turned off. The data voltage b corresponding to the first sub-pixel P1 is input to the first sub-pixel P1 through the data lines (D1, D2, D3 . . . ). At this time, the pixel voltage of the first sub-pixel P1 is charged to the data voltage b because the first thin film transistor T1 is turned on. The pixel voltage of the second sub-pixel P2 continues to be the data voltage g because the second thin film transistor T2 is turned off. The pixel voltage of the third sub-pixel P3 continues to be the data voltage r because the second thin film transistor T2 is turned off and the third thin film transistor T3 is turned on. At this time, the data voltages of the third sub-pixel P3, the second sub-pixel P2 and the first sub-pixel P1 from left to right along the row direction X are r, g and b respectively.
(4) The first gate line G1 and the second gate line G2 are both turned off, and the first thin film transistor T1, the second thin film transistor T2 and the third thin film transistor T3 are all turned off. From left to right along the row direction X, the third sub-pixel P3 maintains the data voltage r, the second sub-pixel P2 maintains the data voltage g, and the first sub-pixel P1 maintains the data voltage b. The first row of pixel unit arrays realizes normal light-emitting display.

Afterwards, the second row of pixel units P, the third row of pixel units P, etc. in sequence implement the light-emitting display of each row according to the above steps (1) to (4).

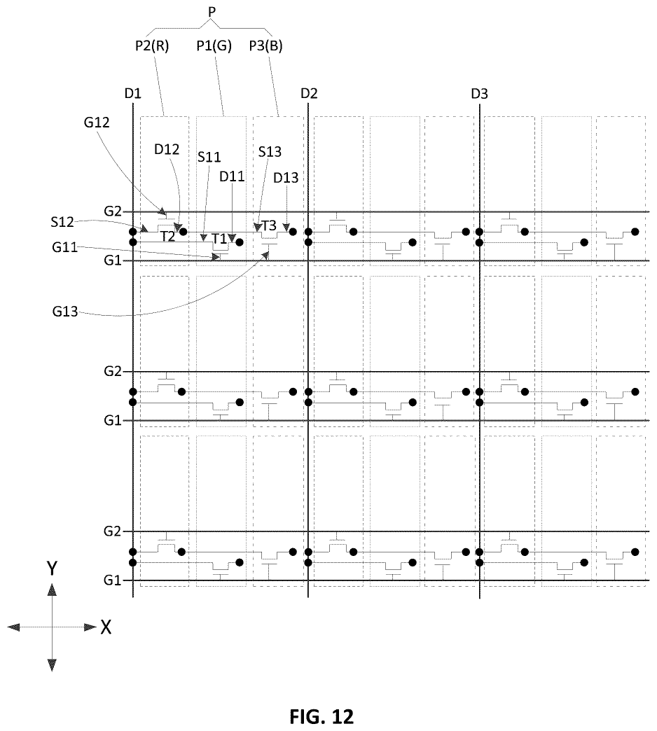

In some embodiments, in the above-mentioned pixel array provided by embodiments of the present disclosure, as shown in FIGS. 12 to 15, the second sub-pixel P2, the first sub-pixel P1 and the third sub-pixel P3 are arranged in sequence along the row direction X, and the data lines (D1, D2, D3 . . . ) are arranged on the side of the second sub-pixel P2 facing away from the first sub-pixel P1. In some embodiments, since the third sub-pixel P3 is connected in series with the second sub-pixel P2, that is, the third thin-film transistor T3 and the second thin-film transistor T2 are connected in series, by arranging the data line (D1, D2, D3 . . . ) on the side of the second sub-pixel P2 facing away from the first sub-pixel P1, the first electrode S11 of the first thin-film transistor T1 and the first electrode S12 of the second thin-film transistor T2 can be electrically connected to the data line on the side of the second sub-pixel P2, thereby simplifying the layout difficulty of the pixel array. Of course, the data lines (D1, D2, D3 . . . ) are not limited to being arranged on the side of the second sub-pixel P2 facing away from the first sub-pixel P1, but can also be set at other positions, as long as the connection relationship between the thin film transistors and the connection relationship between the thin film transistors and the data lines in FIGS. 12 to 15 can be achieved.

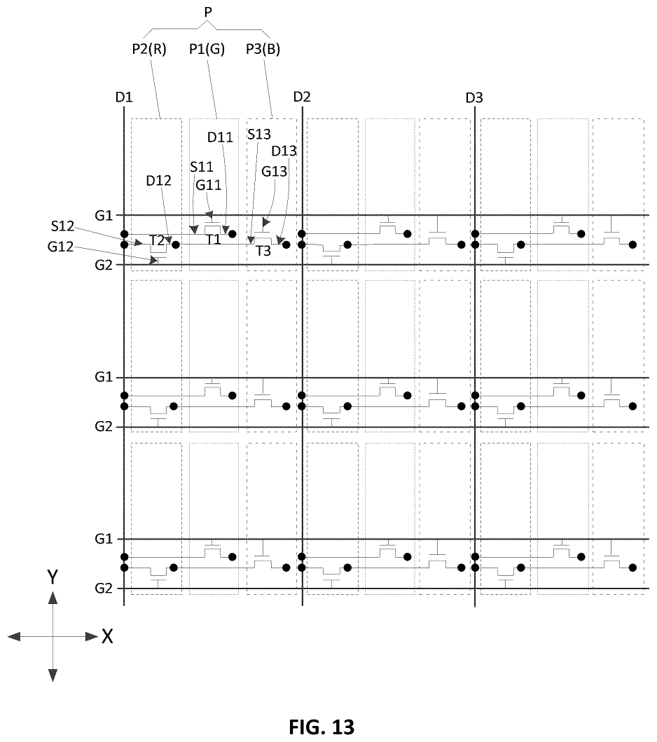

In some embodiments, in the above-mentioned pixel array provided by embodiments of the present disclosure, as shown in FIGS. 12 and 13, the second sub-pixel P2, the first sub-pixel P1 and the third sub-pixel P3 are arranged in sequence from left to right along the row direction X, the luminous color of the second sub-pixel P2 is red (R), the luminous color of the first sub-pixel P1 is green (G), and the luminous color of the third sub-pixel P3 is blue (B). In this way, the leftmost sub-pixel in each pixel unit P is the second sub-pixel P2, and the luminous color is red (R); the middle position of each pixel unit P is the first sub-pixel P1, and the luminous color is green (G); and the rightmost sub-pixel in each pixel unit P is the third sub-pixel P3, and the luminous color is blue (B).

In some embodiments, in the above-mentioned pixel array provided by embodiments of the present disclosure, as shown in FIG. 12, each row of pixel units P corresponds to a first gate line G1 and a second gate line G2, where the second gate line G2 is farther away from the next row of pixel units P, and the first gate line G1 is closer to the next row of pixel units P.

In some embodiments, in the above-mentioned pixel array provided by embodiments of the present disclosure, as shown in FIG. 13, each row of pixel units P corresponds to a first gate line G1 and a second gate line G2, where the first gate line G1 is farther away from the next row of pixel units P, and the second gate line G2 is closer to the next row of pixel units P.

In some embodiments, when the pixel array shown in FIG. 12 and FIG. 13 displays a frame of pixel images, the specific driving method includes the following steps (taking the display of the first row of pixel units P as an example).
(1) The first gate line G1 and the second gate line G2 corresponding to the first row of pixel units P are controlled to be turned on at the same time, and the first thin film transistor T1, the second thin film transistor T2 and the third thin film transistor T3 are turned on at the same time. The data voltage b corresponding to the third sub-pixel P3 is input to the first sub-pixel P1, the second sub-pixel P2 and the third sub-pixel P3 through the data lines (D1, D2, D3 . . . ). The pixel voltages of the first sub-pixel P1, the second sub-pixel P2 and the third sub-pixel P3 are all charged to the data voltage b. At this time, the data voltages of the second sub-pixel P2, the first pixel P1 and the third pixel P3 from left to right along the row direction X are all b.
(2) The first gate line G1 is controlled to be turned on, and the second gate line G2 is controlled to be turned off. At this time, the first thin film transistor T1 and the third thin film transistor T3 are turned on at the same time, and the second thin film transistor T2 is turned off. The data voltage g corresponding to the first sub-pixel P1 is input to the first sub-pixel P1 through the data line (D1, D2, D3 . . . ). At this time, the pixel voltage of the first sub-pixel P1 is charged to g because the first thin film transistor T1 is turned on, and the pixel voltage of the second sub-pixel P2 continues to be maintained at the data voltage b because the second thin film transistor T2 is turned off. The pixel voltage of the third sub-pixel P3 continues to be maintained at the data voltage b because the third thin film transistor T3 is turned on and the second thin film transistor T2 is turned off. At this time, the data voltages of the second sub-pixel P2, the first pixel P1 and the third pixel P3 from left to right along the row direction X are b, g, and b respectively.
(3) The first gate line G1 is controlled to be turned off, and the second gate line G2 is controlled to be turned on. At this time, the first thin film transistor T1 and the third thin film transistor T3 are both turned off, and the second thin film transistor T2 is turned on. The data voltage r corresponding to the second sub-pixel P2 is input to the second sub-pixel P2 through the data line (D1, D2, D3 . . . ). At this time, the pixel voltage of the second sub-pixel P2 is charged to the data voltage r because the second thin film transistor T2 is turned on. The pixel voltage of the first sub-pixel P1 continues to be the data voltage g because the first thin film transistor T1 is turned off. The pixel voltage of the third sub-pixel P3 continues to be the data voltage b because the second thin film transistor T2 is turned on and the third thin film transistor T3 is turned off. At this time, the data voltages of the second sub-pixel P2, the first pixel P1 and the third pixel P3 from left to right along the row direction X are r, g and b respectively.
(4) The first gate line G1 and the second gate line G2 are both turned off, and the first thin film transistor T1, the second thin film transistor T2 and the third thin film transistor T3 are all turned off. From left to right along the row direction X, the second sub-pixel P2 maintains the data voltage r, the first sub-pixel P1 maintains the data voltage g, and the third sub-pixel P3 maintains the data voltage b. The first row of pixel unit arrays realizes normal light-emitting display.

Afterwards, the second row of pixel units P, the third row of pixel units P, etc. in sequence implement the light-emitting display of each row according to the above steps (1) to (4).

In some embodiments, the pixel arrays shown in FIG. 12 and FIG. 13 can also adopt the following driving method when displaying a frame of pixel images (taking the display of the first row of pixel units P as an example).
(1) The first gate line G1 and the second gate line G2 corresponding to the first row of pixel units P are controlled to be turned on at the same time, and the first thin film transistor T1, the second thin film transistor T2 and the third thin film transistor T3 are turned on at the same time. The data voltage b corresponding to the third sub-pixel P3 is input to the first sub-pixel P1, the second sub-pixel P2 and the third sub-pixel P3 through the data lines (D1, D2, D3 . . . ). The pixel voltages of the first sub-pixel P1, the second sub-pixel P2 and the third sub-pixel P3 are all charged to the data voltage b. At this time, the data voltages of the second sub-pixel P2, the first pixel P1 and the third pixel P3 from left to right along the row direction X are all b.
(2) The first gate line G1 is controlled to be turned off, and the second gate line G2 is controlled to be turned on. At this time, the first thin film transistor T1 and the third thin film transistor T3 are turned off at the same time, and the second thin film transistor T2 is turned on. The data voltage r corresponding to the second sub-pixel P2 is input to the second sub-pixel P2 through the data line (D1, D2, D3 . . . ). At this time, the pixel voltage of the second sub-pixel P2 is charged to r because the second thin film transistor T2 is turned on. The pixel voltage of the first sub-pixel P1 continues to be the data voltage b because the first thin film transistor T1 is turned off. The pixel voltage of the third sub-pixel P3 continues to be the data voltage b because the third thin film transistor T3 is turned off and the second thin film transistor T2 is turned on. At this time, the data voltages of the second sub-pixel P2, the first pixel P1 and the third pixel P3 from left to right along the row direction X are r, b, and b respectively.
(3) The first gate line G1 is controlled to be turned on, and the second gate line G2 is controlled to be turned off. At this time, the first thin film transistor T1 and the third thin film transistor T3 are both turned on, and the second thin film transistor T2 is turned off. The data voltage g corresponding to the first sub-pixel P1 is input to the first sub-pixel P1 through the data lines (D1, D2, D3 . . . ). At this time, the pixel voltage of the first sub-pixel P1 is charged to the data voltage g because the first thin film transistor T1 is turned on. The pixel voltage of the second sub-pixel P2 continues to be maintained at the data voltage r because the second thin film transistor T2 is turned off. The pixel voltage of the third sub-pixel P3 continues to be maintained at the data voltage b because the second thin film transistor T2 is turned off and the third thin film transistor T3 is turned on. At this time, the data voltages of the second sub-pixel P2, the first sub-pixel P1 and the third sub-pixel P3 from left to right along the row direction X are r, g, and b respectively.
(4) The first gate line G1 and the second gate line G2 are both turned off, and the first thin film transistor T1, the second thin film transistor T2 and the third thin film transistor T3 are all turned off. From left to right along the row direction X, the second sub-pixel P2 maintains the data voltage r, the first sub-pixel P1 maintains the data voltage g, and the third sub-pixel P3 maintains the data voltage b. The first row of pixel unit arrays realizes normal light-emitting display.

Afterwards, the second row of pixel units P, the third row of pixel units P, etc. in sequence implement the light-emitting display of each row according to the above steps (1) to (4).

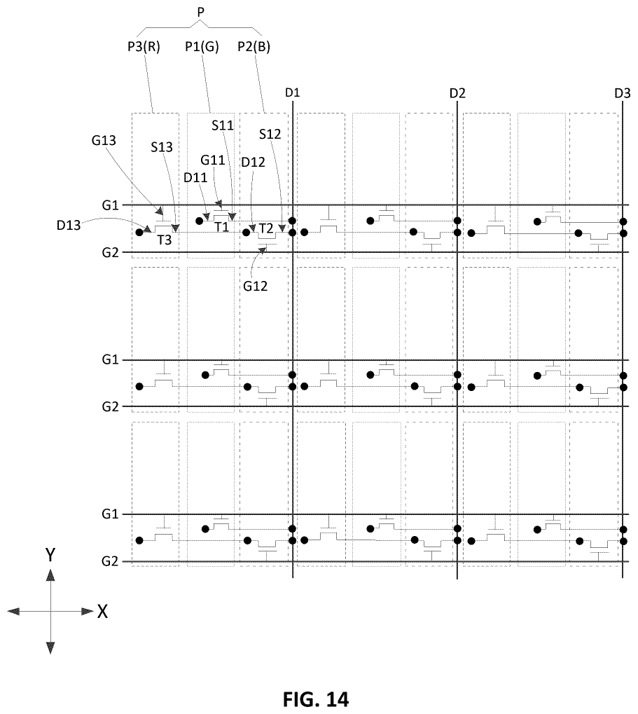

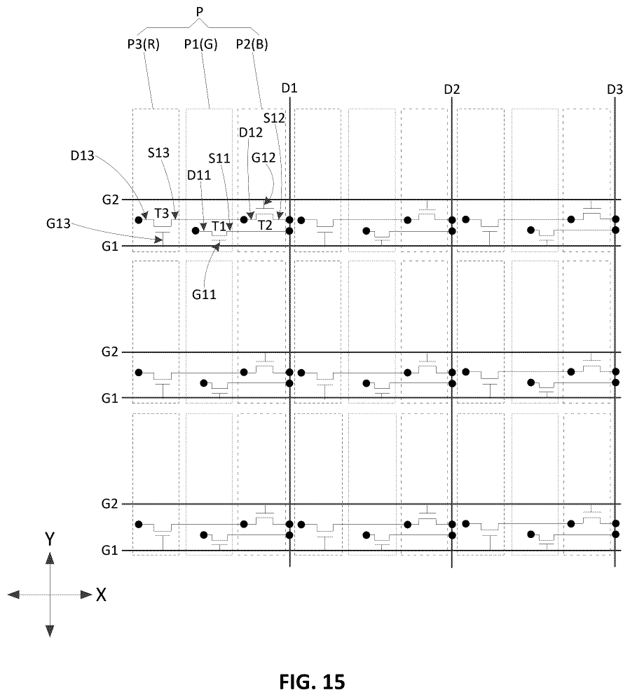

In some embodiments, in the above-mentioned pixel array provided by embodiments of the present disclosure, as shown in FIGS. 14 and 15, the second sub-pixel P2, the first sub-pixel P1 and the third sub-pixel P3 are arranged in sequence from right to left along the row direction X, the luminous color of the second sub-pixel P2 is blue (B), the luminous color of the first sub-pixel is green (G), and the luminous color of the third sub-pixel P3 is red (R). In this way, the leftmost sub-pixel in each pixel unit P is the third sub-pixel P3, and the luminous color is red (R); the middle position in each pixel unit P is the first sub-pixel P1, and the luminous color is green (G); and the rightmost sub-pixel in each pixel unit P is the second sub-pixel P2, and the luminous color is blue (B).

In some embodiments, in the above-mentioned pixel array provided by embodiments of the present disclosure, as shown in FIG. 14, each row of pixel units P corresponds to a first gate line G1 and a second gate line G2, where the first gate line G1 is farther away from the next row of pixel units P, and the second gate line G2 is closer to the next row of pixel units P.

In some embodiments, in the above-mentioned pixel array provided by embodiments of the present disclosure, as shown in FIG. 15, each row of pixel units P corresponds to a first gate line G1 and a second gate line G2, where the second gate line G2 is farther away from the next row of pixel units P, and the first gate line G1 is closer to the next row of pixel units P.

In some embodiments, when the pixel array shown in FIG. 14 and FIG. 15 displays a frame of pixel images, the specific driving method includes the following steps (taking the display of the first row of pixel units P as an example).
(1) The first gate line G1 and the second gate line G2 corresponding to the first row of pixel units P are controlled to be turned on at the same time, and the first thin film transistor T1, the second thin film transistor T2 and the third thin film transistor T3 are turned on at the same time. The data voltage r corresponding to the third sub-pixel P3 is input to the first sub-pixel P1, the second sub-pixel P2 and the third sub-pixel P3 through the data lines (D1, D2, D3 . . . ). The pixel voltages of the first sub-pixel P1, the second sub-pixel P2 and the third sub-pixel P3 are all charged to the data voltage r. At this time, the data voltages of the third sub-pixel P3, the first pixel P1 and the second pixel P2 from left to right along the row direction X are all r.
(2) The first gate line G1 is controlled to be turned on, and the second gate line G2 is controlled to be turned off. At this time, the first thin film transistor T1 and the third thin film transistor T3 are turned on at the same time, and the second thin film transistor T2 is turned off. The data voltage g corresponding to the first sub-pixel P1 is input to the first sub-pixel P1 through the data lines (D1, D2, D3 . . . ). At this time, the pixel voltage of the first sub-pixel P1 is charged to g because the first thin film transistor T1 is turned on, and the pixel voltage of the second sub-pixel P2 continues to be the data voltage r because second thin film transistor T2 is turned off. The pixel voltage of the third sub-pixel P3 continues to be the data voltage r because the third thin film transistor T3 is turned on and the second thin film transistor T2 is turned off. At this time, the data voltages of the third sub-pixel P3, the first sub-pixel P1, and the second sub-pixel P2 from left to right along the row direction X are r, g, and r respectively.
(3) The first gate line G1 is controlled to be turned off, and the second gate line G2 is controlled to be turned on. At this time, the first thin film transistor T1 and the third thin film transistor T3 are both turned off, and the second thin film transistor T2 is turned on. The data voltage b corresponding to the second sub-pixel P2 is input to the second sub-pixel P2 through the data line (D1, D2, D3 . . . ). At this time, the pixel voltage of the second sub-pixel P2 is charged to the data voltage b because the second thin film transistor T2 is turned on. The pixel voltage of the first sub-pixel P1 continues to be the data voltage g because the first thin film transistor T1 is turned off. The pixel voltage of the third sub-pixel P3 continues to be the data voltage r because the second thin film transistor T2 is turned on and the third thin film transistor T3 is turned off. At this time, the data voltages of the third sub-pixel P3, the first sub-pixel P1 and the second sub-pixel P2 from left to right along the row direction X are r, g, and b respectively.
(4) The first gate line G1 and the second gate line G2 are both turned off, and the first thin film transistor T1, the second thin film transistor T2 and the third thin film transistor T3 are all turned off. From left to right along the row direction X, the third sub-pixel P3 maintains the data voltage r, the first sub-pixel P1 maintains the data voltage g, and the second sub-pixel P2 maintains the data voltage b. The first row of pixel unit arrays realizes normal light-emitting display.

Afterwards, the second row of pixel units P, the third row of pixel units P, etc. in sequence implement the light-emitting display of each row according to the above steps (1) to (4).

In some embodiments, the pixel arrays shown in FIG. 14 and FIG. 15 can also adopt the following driving method when displaying a frame of pixel images (taking the display of the first row of pixel units P as an example).
(1) The first gate line G1 and the second gate line G2 corresponding to the first row of pixel units P are controlled to be turned on at the same time, and the first thin film transistor T1, the second thin film transistor T2 and the third thin film transistor T3 are turned on at the same time. The data voltage r corresponding to the third sub-pixel P3 is input to the first sub-pixel P1, the second sub-pixel P2 and the third sub-pixel P3 through the data lines (D1, D2, D3 . . . ). The pixel voltages of the first sub-pixel P1, the second sub-pixel P2 and the third sub-pixel P3 are all charged to the data voltage r. At this time, the data voltages of the third sub-pixel P3, the first pixel P1 and the second pixel P2 from left to right along the row direction X are all r.
(2) The first gate line G1 is controlled to be turned off, and the second gate line G2 is controlled to be turned on. At this time, the first thin film transistor T1 and the third thin film transistor T3 are turned off at the same time, and the second thin film transistor T2 is turned on. The data voltage b corresponding to the second sub-pixel P2 is input to the second sub-pixel P2 through the data line (D1, D2, D3 . . . ). At this time, the pixel voltage of the second sub-pixel P2 is charged to b because the second thin film transistor T2 is turned on. The pixel voltage of the first sub-pixel P1 continues to be the data voltage r because the first thin film transistor T1 is turned off. The pixel voltage of the third sub-pixel P3 continues to be the data voltage r because the third thin film transistor T3 is turned off and the second thin film transistor T2 is turned on. At this time, the data voltages of the third sub-pixel P3, the first sub-pixel P1, and the second sub-pixel P2 from left to right along the row direction X are r, r, and b respectively.
(3) The first gate line G1 is controlled to be turned on, and the second gate line G2 is controlled to be turned off. At this time, the first thin film transistor T1 and the third thin film transistor T3 are both turned on, and the second thin film transistor T2 is turned off. The data voltage g corresponding to the first sub-pixel P1 is input to the first sub-pixel P1 through the data lines (D1, D2, D3 . . . ). At this time, the pixel voltage of the first sub-pixel P1 is charged to the data voltage g because the first thin film transistor T1 is turned on. The pixel voltage of the second sub-pixel P2 continues to be maintained at the data voltage b because the second thin film transistor T2 is turned off. The pixel voltage of the third sub-pixel P3 continues to be maintained at the data voltage r because the second thin film transistor T2 is turned off and the third thin film transistor T3 is turned on. At this time, the data voltages of the third sub-pixel P3, the first sub-pixel P1 and the second sub-pixel P2 from left to right along the row direction X are r, g, and b respectively.
(4) The first gate line G1 and the second gate line G2 are both turned off, and the first thin film transistor T1, the second thin film transistor T2 and the third thin film transistor T3 are all turned off. From left to right along the row direction X, the third sub-pixel P3 maintains the data voltage r, the first sub-pixel P1 maintains the data voltage g, and the second sub-pixel P2 maintains the data voltage b. The first row of pixel unit arrays realizes normal light-emitting display.

Afterwards, the second row of pixel units P, the third row of pixel units P, etc. in sequence implement the light-emitting display of each row according to the above steps (1) to (4).

In some embodiments, in the above pixel array provided by embodiments of the present disclosure, as shown in FIGS. 4 to 15, the two gate lines (the first gate line G1 and the second gate line G2) corresponding to each row of pixel units P are arranged on the same side of the corresponding row of pixel units P. This is beneficial for simplifying the layout of the first thin film transistor T1, the second thin film transistor T2, and the third thin film transistor T3.

In some embodiments, in the above-mentioned pixel array provided by embodiments of the present disclosure, as shown in FIGS. 4 to 15, the thin film transistors (T1, T2, T3) corresponding to each row of pixel units P are arranged between the two gate lines (G1 and G2) of the corresponding row of pixel units P. This is beneficial for simplifying the electrical connection between the first thin film transistor T1 and the third thin film transistor T3 and the first gate line G1, and the electrical connection between the second thin film transistor T2 and the second gate line G2, which is beneficial for simplifying the layout.

In some embodiments, in the above-mentioned pixel array provided by embodiments of the present disclosure, as shown in FIGS. 5, 7, 9 and 11, the pixel array of embodiments of the present disclosure is generally used as a pixel array on the array substrate of a liquid crystal display panel, and a black matrix layer (BM) is generally provided on the opposite substrate (i.e., the color film substrate) of the liquid crystal display panel. The BM is generally provided in the gap between adjacent sub-pixels. On the one hand, it is used to define the sub-pixel region, and on the other hand, it is used to block metal signal lines, such as gate lines, data lines, etc., to prevent the metal signal lines from reflecting and reduce the reflectivity of the display region.

In some embodiments, the above-mentioned pixel array provided by embodiments of the present disclosure further includes other functional film layers well known to those skilled in the art, such as a common electrode layer, and a storage capacitor is formed between the common electrode layer and each pixel electrode.

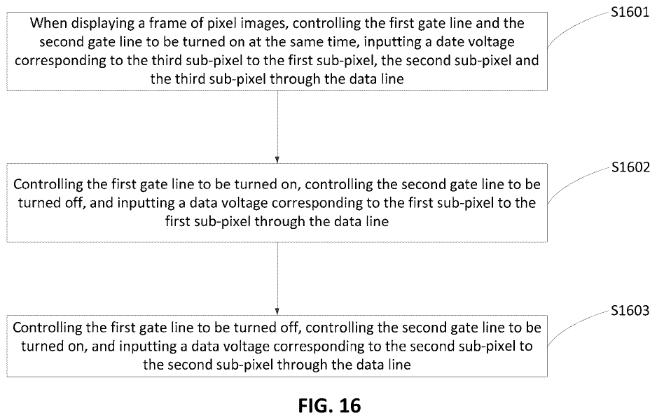

Based on the same inventive concept, embodiments of the present disclosure further provide a method for driving a pixel array, which is used to drive the pixel arrays shown in FIG. 4 to FIG. 15 provided by embodiments of the present disclosure. As shown in FIG. 16, the driving method includes the following operations.

S1601, when displaying a frame of pixel images, controlling the first gate line and the second gate line to be turned on at the same time, inputting a date voltage corresponding to the third sub-pixel to the first sub-pixel, the second sub-pixel and the third sub-pixel through the data line.

S1602, controlling the first gate line to be turned on, controlling the second gate line to be turned off, and inputting a data voltage corresponding to the first sub-pixel to the first sub-pixel through the data line.

S1603, controlling the first gate line to be turned off, controlling the second gate line to be turned on, and inputting a data voltage corresponding to the second sub-pixel to the second sub-pixel through the data line.

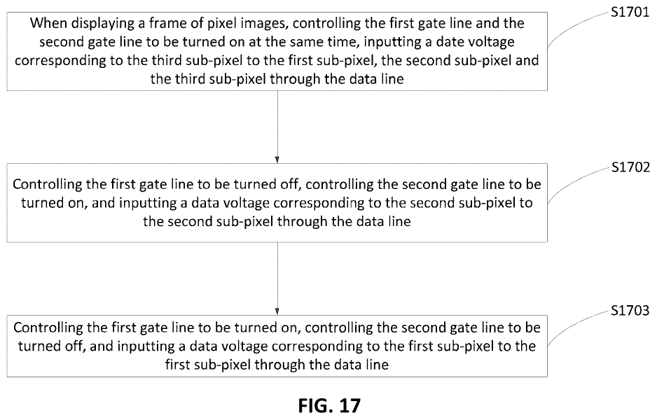

Based on the same inventive concept, embodiments of the present disclosure further provide a method for driving a pixel array, which is used to drive the pixel arrays shown in FIG. 4 to FIG. 15 provided by embodiments of the present disclosure. As shown in FIG. 17, the driving method includes the following operations.

S1701, when displaying a frame of pixel images, controlling the first gate line and the second gate line to be turned on at the same time, inputting a date voltage corresponding to the third sub-pixel to the first sub-pixel, the second sub-pixel and the third sub-pixel through the data line.

S1702, controlling the first gate line to be turned off, controlling the second gate line to be turned on, and inputting a data voltage corresponding to the second sub-pixel to the second sub-pixel through the data line.

S1703, controlling the first gate line to be turned on, controlling the second gate line to be turned off, and inputting a data voltage corresponding to the first sub-pixel to the first sub-pixel through the data line.

The driving method of the above-mentioned two pixel arrays provided by embodiments of the present disclosure can realize display driving of different sub-pixels by using one data line and two gate lines for each pixel unit. Compared with the three-gate pixel structure in the related art, the present disclosure can reduce the number of data lines to ⅓ of the single-gate pixel structure while also reducing the number of gate lines for each row of pixel units. This can increase the display area and improve the aperture ratio on the one hand; on the other hand, the reduction in the number of gate lines can also reduce the parasitic capacitance between the gate lines and other signal lines, thereby increasing the charging time of each row of pixel units, ensuring the charging rate, and improving the display effect.

In some embodiments, the driving principles of the driving methods of the above two pixel arrays provided by embodiments of the present disclosure can refer to the driving principles of the above one pixel array, and will not be described in detail here.

Based on the same inventive concept, embodiments of the present disclosure further provide a display device, including a display panel, where the display panel includes the above-mentioned pixel array provided by embodiments of the present disclosure. The principle of solving the problem of the display device is similar to that of the aforementioned pixel array, so the implementation of the display device can refer to the implementation of the aforementioned pixel array, and the repeated parts will not be repeated here.

In some embodiments, the display device provided by embodiments of the present invention is a liquid crystal display device.

In some embodiments, the display device provided by embodiments of the present invention can be a full-screen display device, or can be a flexible display device, etc., which is not limited here.

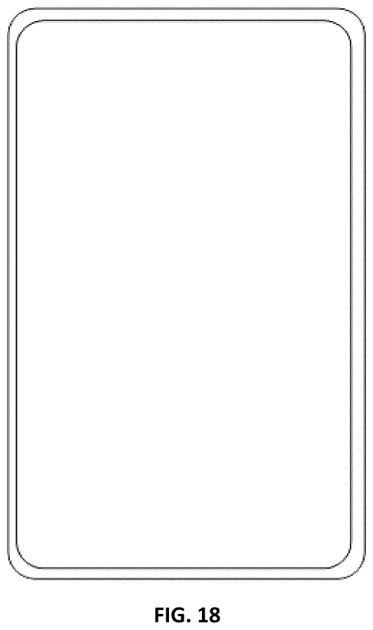

In some embodiments, the display device provided by embodiments of the present invention can be a full-screen mobile phone as shown in FIG. 18. Of course, the display device provided by embodiments of the present invention can also be any product or component with a display function, such as a tablet computer, a television, a monitor, a laptop computer, a digital photo frame, a navigator, or the like. Other essential components of the display device are well understood by those skilled in the art and will not be described in detail herein and should not be construed as limiting the present invention.

Embodiments of the present disclosure provide a pixel array, a driving method thereof, and a display device. By using one data line and two gate lines for each pixel unit, display driving of different sub-pixels can be achieved. Compared with the three-gate pixel structure in the related art, the present disclosure can reduce the number of data lines to ⅓ of the single-gate pixel structure while also reducing the number of gate lines for each row of pixel units. This can increase the display area and improve the aperture ratio on the one hand; on the other hand, the reduction in the number of gate lines can also reduce the parasitic capacitance between the gate lines and other signal lines, thereby increasing the charging time of each row of pixel units, ensuring the charging rate, and improving the display effect.

Evidently those skilled in the art can make various modifications and variations to the present disclosure without departing from the spirit and scope of the present disclosure. Thus the present disclosure is also intended to encompass these modifications and variations therein as long as these modifications and variations to the present disclosure come into the scope of the claims of the present disclosure and their equivalents.

1. A pixel array, comprising:
a plurality of gate lines extending in a row direction and arranged in a column direction;
a plurality of data lines extending in the column direction and arranged in the row direction;
a plurality of pixel units arranged in an array in the row direction and the column direction; wherein:
each of the plurality of pixel units comprises: a first sub-pixel, a second sub-pixel and a third sub-pixel arranged in the row direction;
each column of the plurality of pixel units corresponds to a data line, the first sub-pixel and the second sub-pixel are directly electrically connected to the data line of a corresponding column, and the third sub-pixel is electrically connected to the data line of the corresponding column by being connected in series with the second sub-pixel;
each row of the plurality of pixel units corresponds to two gate lines, the two gate lines comprise a first gate line and a second gate line, the first sub-pixel and the third sub-pixel are both connected to the first gate line of a corresponding row, and the second sub-pixel is connected to the second gate line of the corresponding row.

2. The pixel array according to claim 1, wherein the first sub-pixel comprises: a first thin film transistor and a first pixel electrode; the second sub-pixel comprises: a second thin film transistor and a second pixel electrode; and the third sub-pixel comprises: a third thin film transistor and a third pixel electrode;
a gate electrode of the first thin film transistor and a gate electrode of the third thin film transistor are both connected to the first gate line, and a gate electrode of the second thin film transistor is connected to the second gate line;
a first electrode of the first thin film transistor and a first electrode of the second thin film transistor are directly electrically connected to the data line of the corresponding column;
a second electrode of the first thin film transistor is electrically connected to the first pixel electrode, a second electrode of the second thin film transistor is electrically connected to the second pixel electrode;
a first electrode of the third thin film transistor is electrically connected to the second electrode of the second thin film transistor, and a second electrode of the third thin film transistor is electrically connected to the third pixel electrode.

3. The pixel array according to claim 2, wherein the first sub-pixel, the second sub-pixel, and the third sub-pixel are arranged in sequence in the row direction; and the data line is arranged between the first sub-pixel and the second sub-pixel.

4. The pixel array according to claim 3, wherein the first sub-pixel emits red light, the second sub-pixel emits green light, and the third sub-pixel emits blue light; or
the first sub-pixel emits blue light, the second sub-pixel emits green light, and the third sub-pixel emits red light.

5. The pixel array according to claim 2, wherein the second sub-pixel, the first sub-pixel and the third sub-pixel are arranged in sequence in the row direction, and the data line is arranged on a side of the second sub-pixel facing away from the first sub-pixel.

6. The pixel array according to claim 5, wherein the second sub-pixel emits red light, the first sub-pixel emits green light, and the third sub-pixel emits blue light; or
the second sub-pixel emits blue light, the first sub-pixel emits green light, and the third sub-pixel emits red light.

7. The pixel array according to claim 2, wherein the two gate lines corresponding to each row of the plurality of pixel units are arranged on a same side of the plurality of pixel units in the corresponding row.

8. The pixel array according to claim 7, wherein a plurality of thin film transistors corresponding to each row of the plurality of pixel units are arranged between the two gate lines of the corresponding row of the plurality of pixel units.

9. A display device, comprising a display panel, wherein the display panel comprises the pixel array according to claim 1.

10. A method for driving the pixel array according to claim 1, wherein, when displaying a frame of pixel images, the method comprises:
controlling both the first gate line and the second gate line to be turned on, inputting a date voltage corresponding to the third sub-pixel to the first sub-pixel, the second sub-pixel and the third sub-pixel through the data line;
controlling the first gate line to be turned on, controlling the second gate line to be turned off, and inputting a data voltage corresponding to the first sub-pixel to the first sub-pixel through the data line;
controlling the first gate line to be turned off, controlling the second gate line to be turned on, and inputting a data voltage corresponding to the second sub-pixel to the second sub-pixel through the data line.

11. A method for driving the pixel array according to claim 1, wherein, when displaying a frame of pixel images, the method comprises:
controlling both the first gate line and the second gate line to be turned on, inputting a date voltage corresponding to the third sub-pixel to the first sub-pixel, the second sub-pixel and the third sub-pixel through the data line;
controlling the first gate line to be turned off, controlling the second gate line to be turned on, and inputting a data voltage corresponding to the second sub-pixel to the second sub-pixel through the data line;
controlling the first gate line to be turned on, controlling the second gate line to be turned off, and inputting a data voltage corresponding to the first sub-pixel to the first sub-pixel through the data line.

12. The display device according to claim 9, wherein the first sub-pixel comprises: a first thin film transistor and a first pixel electrode; the second sub-pixel comprises: a second thin film transistor and a second pixel electrode; and the third sub-pixel comprises: a third thin film transistor and a third pixel electrode;
a gate electrode of the first thin film transistor and a gate electrode of the third thin film transistor are both connected to the first gate line, and a gate electrode of the second thin film transistor is connected to the second gate line;
a first electrode of the first thin film transistor and a first electrode of the second thin film transistor are directly electrically connected to the data line of the corresponding column;
a second electrode of the first thin film transistor is electrically connected to the first pixel electrode, a second electrode of the second thin film transistor is electrically connected to the second pixel electrode;
a first electrode of the third thin film transistor is electrically connected to the second electrode of the second thin film transistor, and a second electrode of the third thin film transistor is electrically connected to the third pixel electrode.

13. The display device according to claim 12, wherein the first sub-pixel, the second sub-pixel, and the third sub-pixel are arranged in sequence in the row direction; and the data line is arranged between the first sub-pixel and the second sub-pixel.

14. The display device according to claim 13, wherein the first sub-pixel emits red light, the second sub-pixel emits green light, and the third sub-pixel emits blue light; or the first sub-pixel emits blue light, the second sub-pixel emits green light, and the third sub-pixel emits red light.

15. The display device according to claim 12, wherein the second sub-pixel, the first sub-pixel and the third sub-pixel are arranged in sequence in the row direction, and the data line is arranged on a side of the second sub-pixel facing away from the first sub-pixel.

16. The display device according to claim 15, wherein the second sub-pixel emits red light, the first sub-pixel emits green light, and the third sub-pixel emits blue light; or
the second sub-pixel emits blue light, the first sub-pixel emits green light, and the third sub-pixel emits red light.

17. The display device according to claim 12, wherein the two gate lines corresponding to each row of the plurality of pixel units are arranged on a same side of the plurality of pixel units in the corresponding row.

18. The display device according to claim 17, wherein a plurality of thin film transistors corresponding to each row of the plurality of pixel units are arranged between the two gate lines of the corresponding row of the plurality of pixel units.

19. The pixel array according to claim 3, wherein the two gate lines corresponding to each row of the plurality of pixel units are arranged on a same side of the plurality of pixel units in the corresponding row.

20. The pixel array according to claim 19, wherein a plurality of thin film transistors corresponding to each row of the plurality of pixel units are arranged between the two gate lines of the corresponding row of the plurality of pixel units.
